(19) United States
(12) Patent Application Publication
(10) Pub. No.: US 2024/0330891 A1
(43) Pub. Date: Oct. 3, 2024

(54) OBTAINING A VIRTUAL REPRESENTATION OF A PHYSICAL OBJECT AT POINT OF SALE

(71) Applicant: Toshiba Global Commerce Solutions, Inc., Durham, NC (US)

(72) Inventors: John Pistone, Cary, NC (US); Manda Alane Edwards Miller, Raleigh, NC (US); Kristen Chung, Durham, NC (US)

(21) Appl. No.: 18/126,870

(22) Filed: Mar. 27, 2023

(51) Int. Cl. G06Q 20/20; G06F 3/0488; G06Q 20/12; G06Q 20/36; G06Q 20/38; G06T 17/00

(52) U.S. Cl. CPC G06Q 20/208; G06F 3/0488; G06Q 20/123; G06Q 20/36; G06Q 20/3823; G06T 17/00

(57) ABSTRACT

Systems and methods of obtaining a virtual representation of a physical object at point of sale are presented. In one exemplary embodiment, a POS system includes a first sensor device operable to sense an identifier unique to a physical object and a second sensor device operable to capture a digital image of the physical object during checkout by the POS system. Further, the POS system is communicatively coupled to a blockchain network that includes network nodes that are collectively configured to operate a blockchain. The unique physical object identifier is associated with a cryptographic digital asset stored on the blockchain as a code that represents the unique physical object identifier and a code that represents a reference to a virtual object obtained based on a digital image of the physical object captured by the second sensor during the checkout by the POS system.

### BACKGROUND

Retailers use point of sale hardware and software systems (POS systems) to streamline checkout operations and to allow retailers to process sales, handle payments, and store transactions for later retrieval. POS systems generally comprise a number of components including POS terminals and bagging stations. In a typical retail environment, there are multiple POS terminals in communication with a server over a network. POS systems typically enable customers to scan retail items, determine and indicate the amount owed for those items, prepare and present invoices, allow customers to make payments to retailers for those items, and enable customers or retail staff to bag those items. The POS terminals typically provide multiple payment options during checkout at the POS systems, with most payments being carried out using electronic payment systems in which the transaction is processed, validated, and mediated by a trusted third party such as a financial institution. The bagging stations typically enable customers or retail staff to bag purchased retail items in shopping bags during checkout at the POS systems.

### BRIEF DESCRIPTION OF THE DRAWINGS

The present disclosure will now be described more fully hereinafter with reference to the accompanying drawings, in which embodiments of the disclosure are shown. However, this disclosure should not be construed as limited to the embodiments set forth herein. Rather, these embodiments are provided so that this disclosure will be thorough and complete, and will fully convey the scope of the disclosure to those skilled in the art. Like numbers refer to like elements throughout.

FIGS. 1A-B illustrate embodiments of a system of obtaining a virtual representation of a physical object at point of sale in accordance with various aspects as described herein.

FIGS. 2A-B illustrate embodiments of a POS system in accordance with various aspects as described herein. FIG. 2C illustrates one embodiment of a network node of a blockchain network in accordance with various aspects as described herein.

FIG. 3A illustrates another embodiment of a POS system in accordance with various aspects as described herein. FIG. 3B illustrates another embodiment of a network node of a blockchain network in accordance with various aspects as described herein.

FIGS. 4A-C illustrate embodiments of a method performed by a POS system of obtaining a virtual representation of a physical object at point of sale in accordance with various aspects as described herein. FIG. 4D illustrates one embodiment of a method performed by a network node of a blockchain network of obtaining a virtual representation of a physical object at point of sale in accordance with various aspects as described herein.

FIG. 5 illustrates another embodiment of a POS system in accordance with various aspects as described herein.

### DETAILED DESCRIPTION

For simplicity and illustrative purposes, the present disclosure is described by referring mainly to exemplary embodiments thereof. In the following description, numerous specific details are set forth in order to provide a thorough understanding of the present disclosure. However, it will be readily apparent to one of ordinary skill in the art that the present disclosure may be practiced without limitation to these specific details.

As augmented and virtual reality environments continue to expand, consumers will desire the ability to view and access virtual representations of their purchased physical objects in such virtual or augmented reality environments. Further, a consumer having a computer-generated avatar that represents the consumer or the consumer's character or persona in a virtual or augmented reality environment will desire to have that avatar access or interact with virtual representations of physical objects purchased by the consumer. Consumers will also desire a platform that enables non-fungible tokens (NFTs) to be associated with unique, limited, expensive, or luxury products and to provide proof of authenticity or ownership and access to virtual representations of these products in a virtual or augmented reality environment. In addition, consumers will desire to transfer possession or ownership of purchased products having corresponding NFTs. Accordingly, there is a need for improved methods and techniques to enable consumers to obtain, access, transfer, sell or trade virtual objects that represent purchased retail items in a virtual or augmented reality environment. In addition, other desirable features and characteristics of the present disclosure will become apparent from the subsequent detailed description and embodiments, taken in conjunction with the accompanying figures and the foregoing technical field and background.

In one exemplary embodiment, an NFT can be created on a blockchain and the NFT can be associated with a physical object (e.g., retail item). As possession or ownership of the physical object is transferred through the supply chain (such as from manufacturer to distributor to retailer to consumer), the possession or ownership of the NFT can also be transferred contemporaneous with the transfer of the corresponding physical object. During checkout of the physical object by the consumer, the POS system can obtain a computer-generated virtual object representation of that physical object. Further, the POS system can transfer possession or ownership of the NFT to the consumer such as to a digital wallet associated with a user account of that consumer. The POS system can also associate the virtual object with the NFT. In addition, the POS system can assign the virtual object to a virtual or augmented reality environment in which the consumer has a user account. The consumer can then view and access the virtual object in that virtual or augmented reality environment such as through the consumer's avatar or augmented reality-capable glasses. The consumer can also transfer possession or ownership of the physical object to another consumer, which would enable (e.g., via a smart contract associated with the blockchain) the contemporaneous transfer of the NFT to the other consumer. Additionally or alternatively, the consumer can also transfer possession or ownership of the NFT to another avatar in a virtual reality environment, which would enable the contemporaneous transfer of the physical object to the consumer that has an account in the virtual world associated with that avatar.

In another exemplary embodiment, when consumers purchase real world physical objects that are considered unique, limited, expensive or luxurious and may include a unique identifier (such as for hand bags, watches, computers, and cars), an NFT can be associated with the physical object and the consumer can possess the corresponding NFT. Further, the possession of the NFT can enable the consumer to view or access a virtual representation of the physical object in a virtual or augmented reality environment (e.g., metaverse) displayed on a display device (e.g., VR headset, augmented reality-capable glasses, display device). For instance, a handbag (e.g., Louis Vuitton™) or a car (e.g., Ferrari™) purchased by a consumer can be assigned an NFT that enables the consumer to view or access a virtual object that represents the physical handbag or car in a virtual or augmented reality environment displayed on a display device. Further, the consumer can transfer possession or ownership of the physical handbag or car to another consumer, with the corresponding NFT also being transferred to the other consumer. After such transfer, the consumer will no longer be able to view or access the transferred item both in the virtual or augmented reality environment.

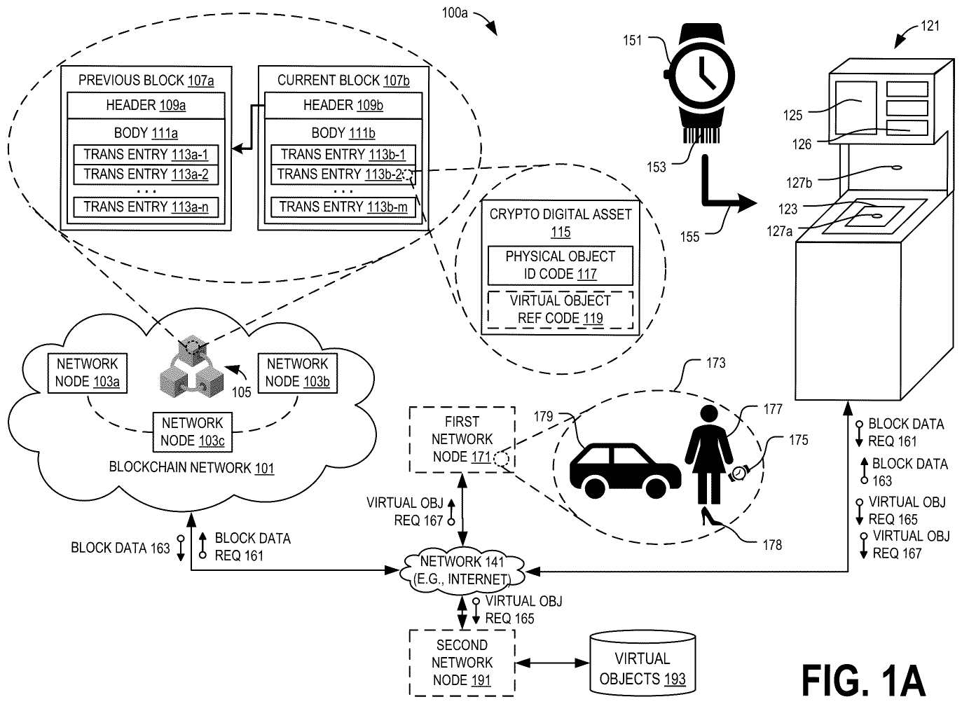

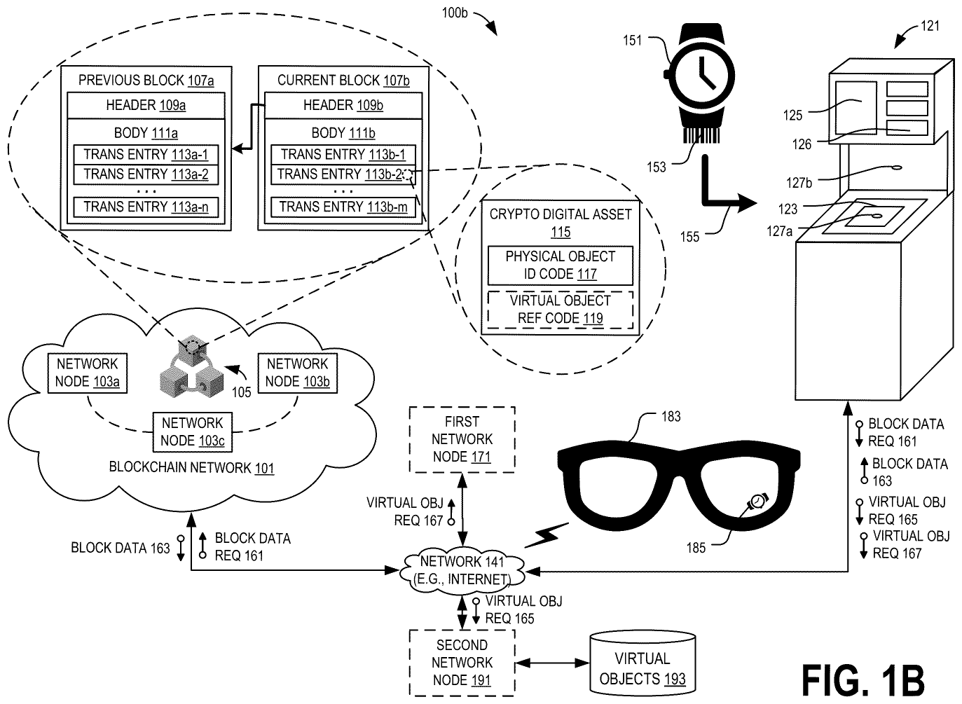

Furthermore, the exemplary embodiments described herein include improved techniques to obtain a computer-generated virtual representation of a physical object at point of sale. For example, FIGS. 1A-B illustrate embodiments of a system 100a-b of obtaining a virtual representation 175, 185 of a physical object 151 (e.g., retail item) at point of sale in accordance with various aspects as described herein. In FIGS. 1A-B, the system 100a-b includes a POS system or device 121 (e.g., self-checkout device, assisted checkout device, self-service checkout device, checkout device) coupled to a blockchain network 101, a first network node 171 (e.g., virtual or augmented reality environment server), and a second network node 191 (e.g., virtual object repository server) over a network 141 (e.g., Internet, intranet). The POS device 121 can include first and second sensor devices 127a-b (e.g., camera, code scanner, radio frequency identification (RFID) device, near field communication (NFC) device), a weight scale 123, the like, or any combination thereof. The POS device 121 can also include a user interface device 125, 126 (e.g., touchscreen display, LED, keypad, payment reader, printer, credit card reader), or the like. The weight scale 123 is operable to measure a weight of an item (e.g., produce) placed on the surface of the scale 123. The weight scale 123 can include the first sensor device 127a (e.g., scanner scale) that is operable to scan a quick response (QR) or bar code positioned on a physical object that is moved over the window surface of the scale 123. The first sensor device 127a can include an RFID detector device that is operable to detect an RFID tag disposed with the physical object 151. Further, the integrated sensing device 127a can include a near field communication (NFC) device that is operable to communicate with an NFC device disposed with the physical object 151. Further, the POS device 121 can be operable to obtain a unique physical object identifier 153 associated with the physical object 151 from the sensed information captured by the first sensor device 127a.

In FIGS. 1A-B, the blockchain network 101 can be a network having a set of network nodes 103a-b (e.g., servers) that are configured to store and manage a blockchain 105, including the generation, verification, and addition of new blocks to the blockchain 105. The blockchain 105 can include a set of blocks 107a-b with each block 107a-b having a block header 109a-b and a body 111a-b having a set of transaction entries 113a-1-n, 113b-1-n. The block header 109b of a current block 107b can include a reference to a previous block 107a, a timestamp that represents a time when the current block 107b was generated, and a reference to the set of transaction entries 113b-1 to 113b-n included in the current block 107b. Every block 107a-b in the blockchain 105 can be verified by determining the reference values using the associated hashing function. The references included in the blockchain 105 can be hash values generated by applying one or more hashing algorithms to the corresponding data. In one example, the reference to the previous block 107a can be a hash value generated by applying a hashing algorithm to the block header 109a of the previous block 107a. The use of the references reflects the immutability of the blockchain 105, as a change to any transaction entry 113a-1-n, 113b-1-n in the blockchain 105 would result in a different reference value, which would result in the block header 109a-b of the corresponding block 107a-b to be changed, which in turn would result in a difference reference value for that block header 109a-b, requiring the block headers of all previous blocks to change. The set of transaction entries 113a-1-n, 113b-1-n can be represented by a hash tree. For example, the set of transaction entries 113a-1-n, 113b-1-n can be represented by a Merkle tree. A Merkle tree is a hash-based tree structure with each leaf node being a hash of a block 107a-b, and each non-leaf node being a hash of the children of each block 107a-b. Merkle trees can have a branching factor of two with each node having up to two children.

Each transaction entry 113a-1-n, 113b-1-n may represent a cryptographic digital asset 115 (e.g., NFT) specific to the physical object 151 that includes a code 117 associated with the unique physical object identifier 153. Further, each cryptographic digital asset 115 can include a code 119 that represents a reference to a virtual object representation of the physical object 151. The blockchain 105 can include security methods such as the use of public-key cryptography, which may also be referred to as asymmetric key cryptography or encryption. Public-key cryptography uses pairs of mathematically-related keys (i.e., one public key and one private key) to authenticate messages. The private key can be kept secret and can be used to decrypt data. The public key can be shared and can be used to authenticate or encrypt the data. Further, a private key is like a password that enables access to the corresponding cryptographic digital asset or the means to otherwise interact with the various capabilities that the blockchain 105 can support. In one example, each code 117, 119 can include a cryptographic token and a public or private key. Each cryptographic digital asset 115 can be transferred to a digital wallet of another user account and recorded on a new block to confirm the transfer of that cryptographic digital asset 115. In addition, each transfer of a cryptographic digital asset 115 to a digital wallet of a user account may include sending an electronic message (e.g . . . , email, text message) to the user with a unique key and a hashed address to the cryptographic digital asset 115. A skilled artisan will readily recognize that any type of information can be stored in a transaction entry of a block and that data so stored may be stored in publicly readable form or in encrypted form depending on the use in which that particular blockchain is intended. While in one embodiment, the identifier code 117 or the reference code 119 may be encrypted, in another embodiment, the identifier or the reference may be provided in publicly available form depending on the use in which the blockchain is intended.

The first network node 171 can be operable to implement a virtual or augmented reality environment 173, 183. Further, the first network node 171 is operable to have the virtual object 175, 185 assigned to the virtual or augmented reality environment 173, 183. In one example, the first network node 171 can receive a request, from the POS system 121, to assign the virtual object 175, 185 to a certain user account of the virtual or augmented reality environment 173, 183, with the request including the virtual object reference to the virtual object 175, 185. In response, the first network node 181 can assign that virtual object 175, 185 to the certain user account based on the virtual object reference. In another example, the first network node 171 can receive, from the POS system 121, a request to assign the virtual object 175 to a certain avatar 177 of the virtual reality environment 173, with the request including the virtual object reference to the virtual object 175, 185. In response, the first network node 171 can assign that virtual object 175 to the certain avatar 177 based on the virtual object reference. In addition, the first network node 171 can be operable to manage other virtual objects 178, 179 in the virtual or augmented reality environment 173, 183. The second network node 191 can be operable to manage a virtual object repository 193 associated with the crypto digital assets 115 stored in the blockchain 105. In one example, the second network node 191 can receive an indication that includes a request to update the virtual object 175, 185 stored in the virtual object repository 193, with the indication including that virtual object 175, 185 and the corresponding virtual object reference. A virtual object reference represents a reference to a certain virtual object. In one example, a virtual object reference is associated with a network address (e.g., internet protocol (IP) address, media access control (MAC) address) or a web address (e.g., a uniform resource locator (URL)) to a network node configured to have access to the virtual object 175, 185 based on the virtual object reference. In another example, the virtual object reference is associated with account information (e.g., URL, user name, password) that enables access to the virtual object 175, 185. The second network node 191 can then update the virtual object 175, 185 based on the virtual object 175, 185 and the corresponding virtual object reference. In another example, the second network node 191 can receive an indication that includes a request to obtain a virtual object stored in the virtual object repository 193, with the indication including the corresponding virtual object reference. In response, the second network node 191 can obtain the virtual object based on the corresponding virtual object reference and then send the virtual object to the requesting network node.

In FIGS. 1A-B, in operation during checkout of the physical object 151 (e.g., watch), the POS device 121 can receive, from the first sensor device 127a, an indication associated with the unique physical object identifier 153. In one example, the unique physical object identifier 153 is associated with a QR code or a barcode displayed on an outer surface of the container and the first sensor device 127a (e.g., optical scanner, bar code scanner, camera) is operable to capture the QR or bar code displayed on the physical object 151 so that the POS device 121 can obtain the unique physical object identifier 153 based on the captured code. In another example, the unique physical object identifier 153 is associated with a passive or active RFID tag disposed with the physical object 151 and the first sensor device 127a is an RFID detector device operable to sense the RFID so that the POS device 121 can obtain the unique physical object identifier 153 based on the sensed RFID. In yet another example, the unique physical object identifier 153 is an NFC device and the first sensor device 127a is an NFC device that is operable to communicate with the container identifier NFC device to obtain the unique physical object identifier 153.

Furthermore, the POS device 121 can determine that the physical object 151 is associated with the cryptographic digital asset 115 such as by accessing a database that includes information associated with the physical object 151, including an indication of whether that physical object 151 has a unique physical object identifier or is associated with a cryptographic digital asset. In response and/or upon validation of payment for the purchase of the physical object 151 during checkout, the POS device 121 can transfer possession or ownership of the cryptographic digital asset 115 to a digital wallet associated with a user account of the consumer. A skilled artisan will readily recognize techniques for transferring possession or ownership of an NFT. The POS device 121 can also output, for display on a presence sensitive display 125, 126 of the POS system 121, a visual representation associated with a request to obtain a virtual object 175, 185 based on the physical object 151 and in response, receive, from the display 125, 126, an indication of a touch gesture detected at or about that visual representation. The POS device 121 can determine to obtain the virtual object 175, 185 based on the received touch gesture indication. The POS device 121 can then output, for display on the display device 125, 126, a visual representation associated with a request to position the physical object 151 on or about the surface of the weight scale 123. In response, the POS system 121 can receive, from the second sensor device 127b (e.g., optical sensor, camera), an indication that includes a digital image of the physical object 151. The second sensor device 127b can have a field of detection that includes the region on or about the surface of the weight scale 123.

Moreover, the POS system 121 can obtain the virtual object 175, 185 based on the captured digital image of the physical object 151. The POS system 121 can obtain a visual characteristic (e.g., color, shape, design, contour, size, feature) of the physical object 151. The POS system 121 can also obtain a second virtual object having an appearance when displayed in the augmented or virtual environment 173, 183 of a certain form (e.g., common or generic form) of the physical object 151, with the second virtual object being configured to be modifiable based on one or more visual characteristics. The POS system 121 can then modify the second virtual object based on the obtained visual characteristic of the physical object 151 to obtain the virtual object 175, 185.

In FIGS. 1A-B, the POS device 121 can obtain a reference to the crypto digital asset 115 stored in the blockchain 105 based on the unique physical object identifier 153. The POS device 121 can send, to the blockchain network node 130a-c over the network 141, an indication 161 that includes a request for block data associated with the cryptographic digital asset 115, with the indication 161 including the reference to the cryptographic digital asset 115. In one example, the unique physical object identifier 153 represents the blockchain address of the cryptographic digital asset 115 stored in the blockchain 105. In another example, the POS device 121 obtains the blockchain address of the cryptographic digital asset 115 from a look-up table based on the unique physical object identifier 153. The blockchain network node 130a-c can receive the block data request indication 161, can obtain the block data request and the corresponding blockchain reference from the request indication 161, and can validate the block data request based on the corresponding blockchain reference. Further, the blockchain network node 130a-c can obtain the block data 163 associated with the crypto digital asset 115 from the blockchain 105 based on the corresponding blockchain reference and can then send, to the POS device 121 over the network 141, the block data 163 associated with the cryptographic digital asset 115. The block data 163 can include the unique physical object identifier code 117 or the virtual object reference code 119.

In the current embodiment, the POS system 121 can receive the block data 163 associated with the cryptographic digital asset 115 and can obtain, based on the received block data 163, the virtual object reference code 119. The POS system 121 can obtain the virtual object reference based on the virtual object reference code 119 and a corresponding public key or a private key. In one example, the public key or the private key may be included in a digital wallet account associated with the cryptographic digital asset 115. The POS system 121 can associate the virtual object 175, 185 with the cryptographic digital asset 115. In one example, the POS system 121 can store the virtual object 175, 185 in memory (such as in the cloud or the blockchain 105) that corresponds to the virtual object reference. For instance, the POS system 121 can send, to the second network node 191 having the virtual object repository 193, an indication 165 that includes a request to update the virtual object 175, 185 stored in the repository 193, with the request including the virtual object reference or the virtual object 175, 185. In addition, the POS system 121 can assign the virtual object 175, 185 to the augmented or virtual reality environment 173, 183. For instance, the POS system 121 can send, to the first network node 171, an indication 167 that includes a request to assign the virtual object to the virtual or augmented reality environment 173, 183 (such as to a user account or an avatar of the consumer that is associated with the environment 173, 183), with the request including the virtual object reference or the virtual object 175, 185. In response, the first network node 171 can assign the virtual object to the virtual or augmented reality environment 173, 183. Further, the first network node 171 can obtain the virtual object 175, 185 such as from the virtual object repository 193 associated with the second network node 191 based on the virtual object reference.

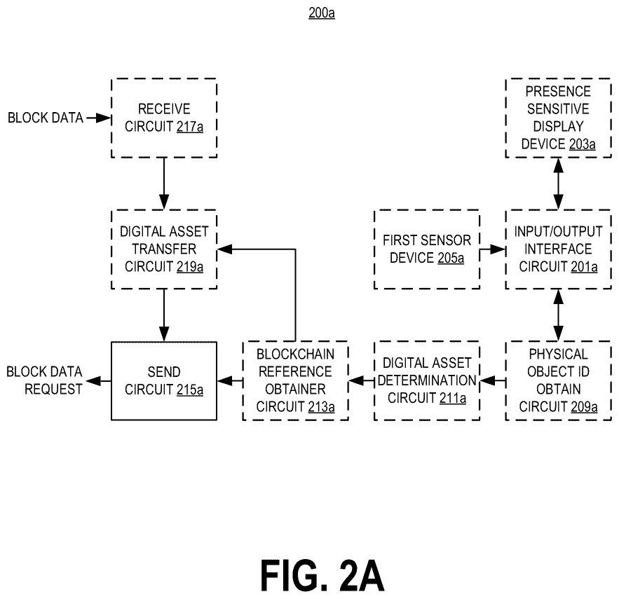

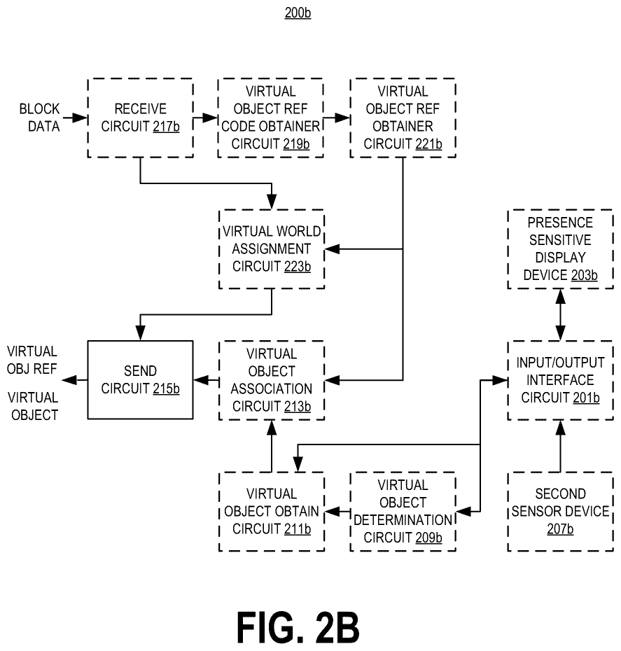

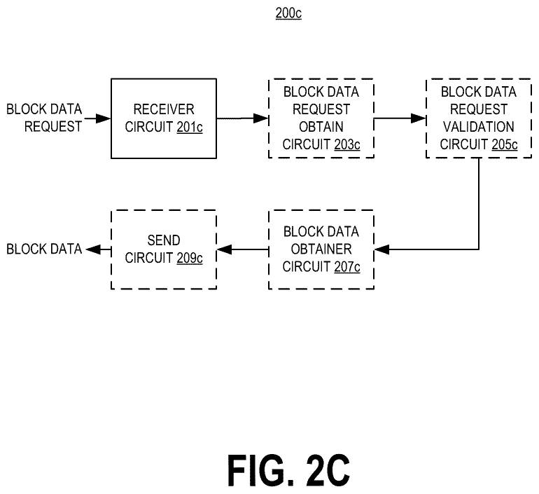

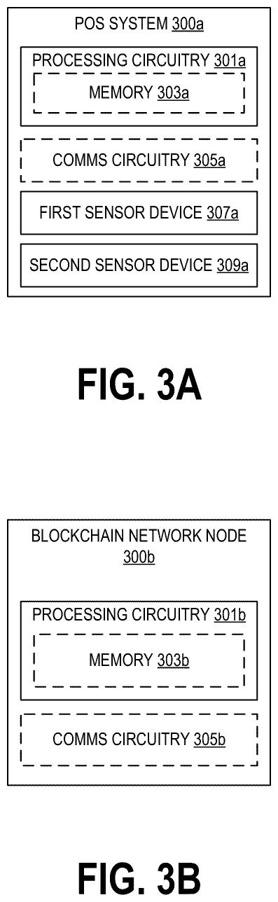

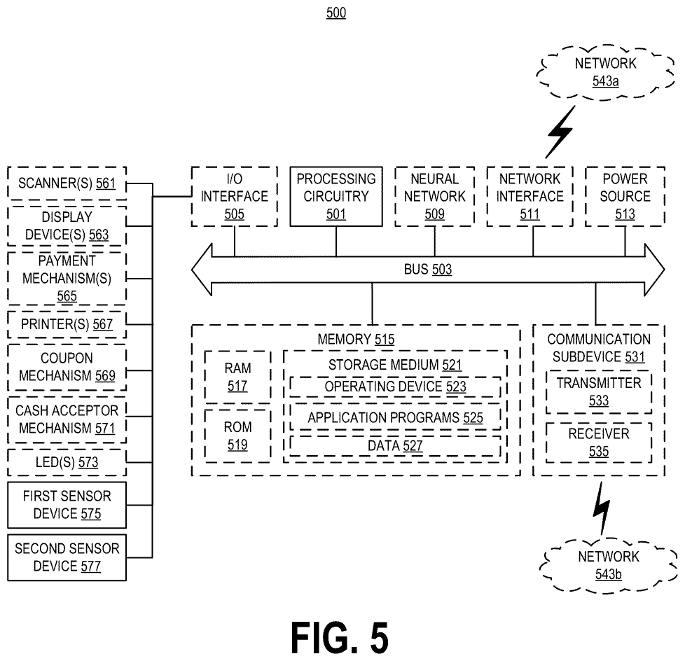

FIG. 2A illustrates one embodiment of a POS system or device 200a in accordance with various aspects as described herein. In FIG. 2A, the device 200a implements various functional means, units, or modules (e.g., via the processing circuitry 301a in FIG. 3A, via the processing circuitry 501 in FIG. 5, via software code, or the like), or circuits. In one embodiment, these functional means, units, modules, or circuits (e.g., for implementing the method(s) described herein) may include for instance: an input/output interface circuit 201a operable to communicate with input and/or output devices including the presence sensitive display device 203a (e.g., touchscreen) and the first sensor device 205a (e.g., scanner, RFID detector, NFC device, optical sensor, camera); a physical object identifier obtain circuit 209a operable to obtain a physical object identifier from a sensed physical object identifier; a digital asset determination circuit 211a operable to determine that a physical object is associated with a unique physical object identifier or a cryptographic digital asset; a blockchain reference obtainer circuit 213a operable to obtain a blockchain reference based on a unique physical object identifier; a send circuit 215a operable to send communications such as to a network node; a receive circuit 217a operable to receive communications such as from a network node; and a cryptographic digital asset transfer circuit 219a operable to transfer possession or ownership of a cryptographic digital asset such as to a digital wallet user account.

FIG. 2B illustrates one embodiment of a POS system 200b in accordance with various aspects as described herein. In FIG. 2B, the device 200b implements various functional means, units, or modules (e.g., via the processing circuitry 301a in FIG. 3A, via the processing circuitry 501 in FIG. 5, via software code, or the like), or circuits. In one embodiment, these functional means, units, modules, or circuits (e.g., for implementing the method(s) described herein) may include for instance: a transaction information obtainer circuit 201b operable to an input/output interface circuit 201b operable to communicate with input and/or output devices including the presence sensitive display device 203b and the second sensor device 207b (e.g., optical sensor, camera); a virtual object determination circuit 209b operable to determine whether a physical object identifier is a unique physical object identifier or is associated with a cryptographic digital asset; a virtual object obtain circuit 211b operable to obtain a virtual object based on a digital image captured by the second sensor device 207b; a virtual object association circuit 213b operable to associate a virtual object with a cryptographic digital asset based on a virtual object reference identifier associated with the cryptographic digital asset; a send circuit 215b operable to send communications such as to a network node; a receive circuit 217b operable to receive communications such as from a network node; a virtual object reference code obtainer circuit 219b operable to obtain a virtual object reference code based on received block data; a virtual object reference obtainer circuit 221b operable to obtain the virtual object reference based on a virtual object reference code; and a virtual or augmented reality environment assignment circuit 223b operable to assign the virtual object to a virtual or augmented reality environment based on a virtual object reference.

FIG. 2C illustrates one embodiment of a network node device 200c in accordance with various aspects as described herein. In FIG. 2C, the device 200c implements various functional means, units, or modules (e.g., via the processing circuitry 301b in FIG. 3B, via software code, or the like), or circuits. In one embodiment, these functional means, units, modules, or circuits (e.g., for implementing the method(s) herein) may include for instance: a receiver circuit 201c operable to receive information such as from a network node; a block data request obtain circuit 203c operable to obtain a block data request and a cryptographic digital asset reference from the received request indication; a block data request validation circuit 205c operable to verify a block data request based on a corresponding cryptographic digital asset reference; a block data obtain circuit 207c operable to obtain block data based on a cryptographic digital asset reference; and a send circuit 209c operable to send communications such as to a network node.

FIG. 3A illustrates another embodiment of a POS system 300a in accordance with various aspects as described herein. In FIG. 3A, the system 300a may include processing circuitry 301a that is operably coupled to one or more of the following: memory 303a and network communications circuitry 305a, a first sensor device 307a, a second sensor device 390a, the like, or any combination thereof. The network communication circuitry 305a is configured to transmit and/or receive information to and/or from one or more other network node devices via any communication technology. The processing circuitry 301a is configured to perform processing described herein, such as by executing instructions stored in memory 303a. The processing circuitry 301a in this regard may implement certain functional means, units, or modules.

FIG. 3B illustrates another embodiment of a network node device 300b in accordance with various aspects as described herein. In FIG. 3B, the device 300b may include processing circuitry 301b that is operably coupled to one or more of the following: memory 303b and network communications circuitry 305b, the like, or any combination thereof. The network communication circuitry 305b is configured to transmit and/or receive information to and/or from one or more other network node devices via any communication technology. The processing circuitry 301b is configured to perform processing described herein, such as by executing instructions stored in memory 303b. The processing circuitry 301b in this regard may implement certain functional means, units, or modules.

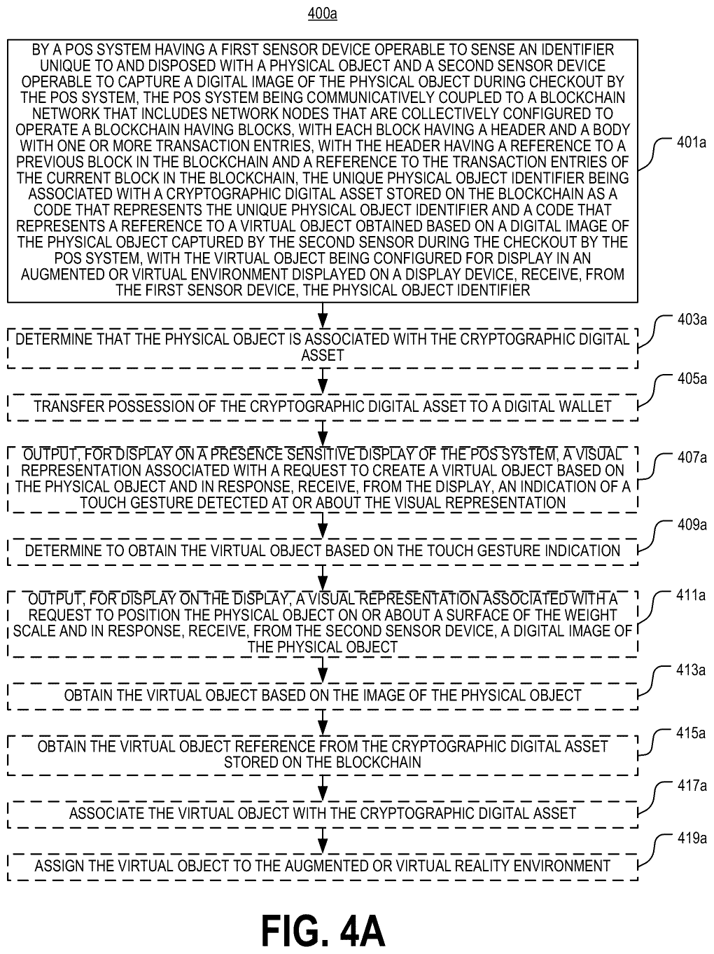

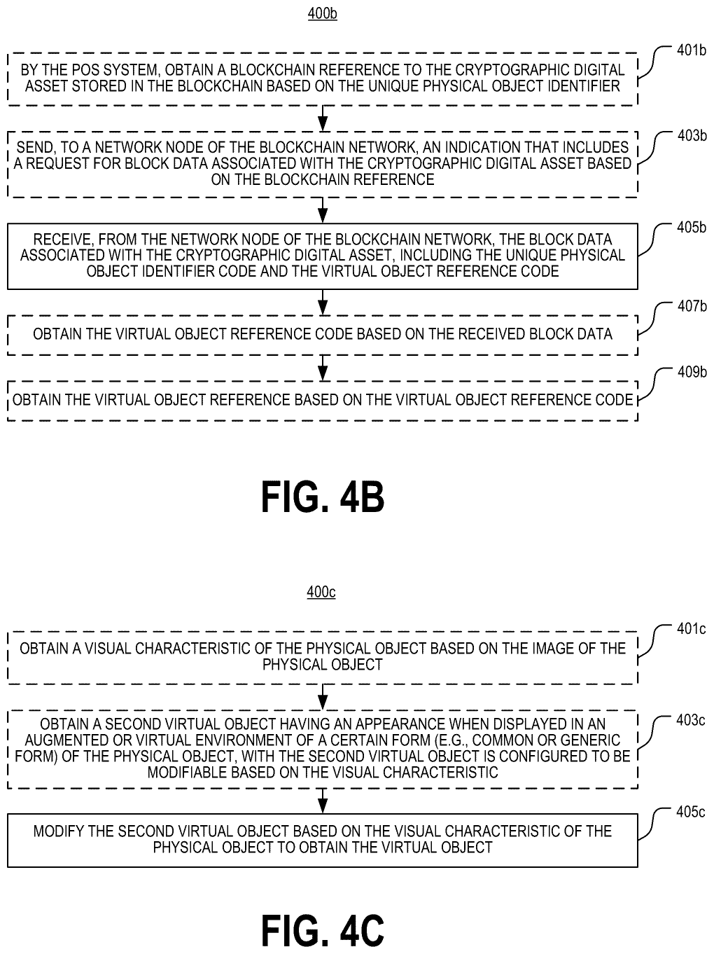

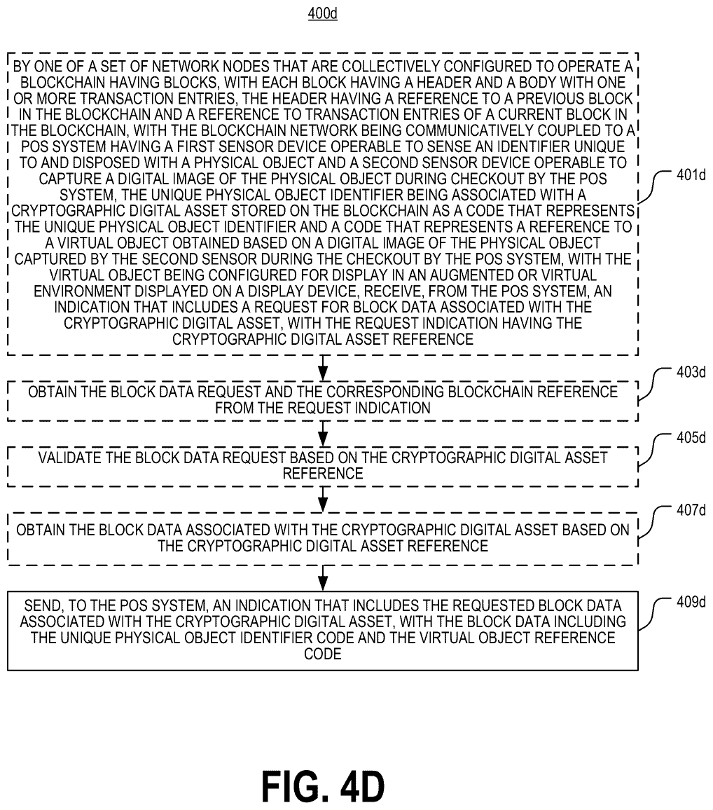

FIG. 4A illustrates one embodiment of a method 400a performed by the POS system 121, 200a-b, 300a, 500 of obtaining a virtual representation of a physical object at point of sale in accordance with various aspects as described herein. In FIG. 4A, the method 400a may start, for instance, at block 401a where it includes receiving, from a first sensor device, the physical object identifier. At block 403a, the method 400a may include determining that the physical object is associated with the cryptographic digital asset. At block 405a, the method 400a may include transferring possession of the cryptographic digital asset such as to a digital wallet. At block 407a, the method 400a may include outputting, for display, a visual representation associated with a request to obtain a virtual object based on the physical object and in response, receiving, from the display, an indication of a touch gesture detected at or about the visual representation. In response, the method 400a may include determining to obtain the virtual object based on the touch gesture indication, as represented by block 409a. At block 411a, the method 400a may include outputting, for display, a visual representation associated with a request to position the physical object on or about a surface of the weight scale and in response, receiving, from the second sensor device, a digital image of the physical object. At block 413a, the method 400a may include obtaining the virtual object based on the digital image of the physical object. The method 400a may include obtaining the virtual object reference from the cryptographic digital asset stored on the blockchain, as represented by block 415a. At block 417a, the method 400a may include associating the virtual object to the cryptographic digital asset based on the virtual object reference. At block 419a, the method 400a may include assigning the virtual object to the augmented or virtual reality environment based on the virtual object reference.

FIG. 4B illustrates another embodiment of a method 400b performed by the POS system 121, 200a-b, 300a, 500 of obtaining a virtual representation of a physical object at point of sale in accordance with various aspects as described herein. In FIG. 4B, the method 400b may start, for instance, at block 401b where it may include obtaining a blockchain reference to the cryptographic digital asset stored in the blockchain based on the unique physical object identifier. At block 403b, the method 400b may include sending, to a network node of the blockchain network, an indication that includes a request for block data associated with the cryptographic digital asset based on the blockchain reference. In response, the method 400b includes receiving, from the network node of the blockchain network, the block data associated with the cryptographic digital asset, including the unique physical object identifier code and the virtual object reference code, as represented by block 405b. At block 407b, the method 400b may include obtaining the virtual object reference code based on the received block data. At block 409b, the method 400b may include obtaining the virtual object reference based on the virtual object reference code.

FIG. 4C illustrates another embodiment of a method 400c performed by the POS system 121, 200a-b, 300a, 500 of obtaining a virtual representation of a physical object at point of sale in accordance with various aspects as described herein. In FIG. 4C, the method 400c may start, for instance, at block 401c where it includes obtaining a visual characteristic of the physical object based on the digital image of the physical object. At block 403c, the method 400c may include obtaining a second virtual object having an appearance when displayed in an augmented or virtual environment of a certain form (e.g., common or generic form) of the physical object, with the second virtual object is configured to be modifiable based on the visual characteristic. At block 405c, the method 400c includes modifying the second virtual object based on the visual characteristic of the physical object to obtain the virtual object.

FIG. 4D illustrates another embodiment of a method 400d performed by the network node 103a-c, 200c, 300b, of obtaining a virtual representation of a physical object at point of sale in accordance with various aspects as described herein. In FIG. 4D, the method 400d may start, for instance, at block 401d where it includes receiving, from the POS system 121, 200a-b, 300a, 500, an indication that includes a request for block data associated with the cryptographic digital asset, with the request indication having the cryptographic digital asset reference. At block 403d, the method 400d may include obtaining the block data request and the corresponding blockchain reference from the request indication. At block 405d, the method 400d may include validating the block data request based on the cryptographic digital asset reference. At block 407d, the method 400d may include obtaining the block data associated with the cryptographic digital asset based on the cryptographic digital asset reference. At block 409d, the method 400d includes sending, to the POS system 121, 200a-b, 300a, 500, an indication that includes the requested block data associated with the cryptographic digital asset, with the block data including the unique physical object identifier code and the virtual object reference code.

FIG. 5 illustrates another embodiment of a POS system or device 500 in accordance with various aspects as described herein. In FIG. 5, device 500 includes processing circuitry 501 that is operatively coupled to input/output interface 505, neural network circuit 509, network connection interface 511, power source 513, memory 515 including random access memory (RAM) 517, read-only memory (ROM) 519 and storage medium 521, communication subsystem 531, and/or any other component, or any combination thereof.

The input/output interface 505 may be configured to provide a communication interface to an input device, output device, or input and output device. The device 500 may be configured to use an output device via input/output interface 505. An output device may use the same type of interface port as an input device. For example, a USB port or a Bluetooth port may be used to provide input to and output from the device 500. The output device may be a speaker, a sound card, a video card, a display, a monitor, a printer, an actuator, an emitter, a smartcard, another output device, or any combination thereof. The device 500 may be configured to use an input device via input/output interface 505 to allow a user to capture information into the device 500. The input device may include a touch-sensitive or presence-sensitive display, an optical sensor, (e.g., a digital camera, a digital video camera, a web camera, a scanner, etc.), a scanner, a weight scale, a microphone, a sensor, a mouse, a trackball, a directional pad, a trackpad, a scroll wheel, a smartcard, and the like. In one example, the input device may be a combined scale and scanner. The scale can be operable to weigh one or more items placed on a transparent window associated with the combined scale and scanner. The scanner can be operable to scan an identifier (e.g., barcode, Q/R code, RF ID) disposed with a scanned item. The presence-sensitive display may include a capacitive or resistive touch sensor to sense input from a user. As shown in FIG. 5, the input/output interface 505 can be configured to provide a communication interface to various input/output components such as a scanners or sensors 561, a display device 563, a payment processing mechanism 565, a printer 567, a coupon slot mechanism 569, a cash acceptor mechanism 571, a light emitting device 573, a first sensor device 575, a second sensor device 577, the like, or any combination thereof. A sensor device may be, for instance, a scanner, an accelerometer, a gyroscope, an RFID detector device, an NFC communication device, a tilt sensor, a force sensor, a magnetometer, an optical or digital image sensor, an infrared sensor, a proximity sensor, another like sensor, or any combination thereof.

In FIG. 5, storage medium 521 may include operating system 523, application program 525, data 527, resolution data 529, the like, or any combination thereof. In other embodiments, storage medium 521 may include other similar types of information. Certain devices may utilize all of the components shown in FIG. 5, or only a subset of the components. The level of integration between the components may vary from one device to another device. Further, certain devices may contain multiple instances of a component, such as multiple processors, memories, neural networks, network connection interfaces, transceivers, etc.

In FIG. 5, processing circuitry 501 may be configured to process computer instructions and data. Processing circuitry 501 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 501 may include two central processing units (CPUs). Data may be information in a form suitable for use by a computer.

In FIG. 5, the neural network circuit 509 may be configured to learn to perform tasks by considering examples such as determining one or more characteristics of a physical object displayed in a digital image. The network connection interface 511 may be configured to provide a communication interface to network 543a. The network 543a may encompass wired and/or wireless networks such as a local-area network (LAN), a wide-area network (WAN), a computer network, a wireless network, a telecommunications network, another like network or any combination thereof. For example, network 543a may comprise a Wi-Fi network. The network connection interface 511 may be configured to include a receiver and a transmitter interface used to communicate with one or more other devices over a communication network according to one or more communication protocols, such as Ethernet, TCP/IP, SONET, ATM, or the like. The network connection interface 511 may implement receiver and transmitter functionality appropriate to the communication network links (e.g., optical, electrical, and the like). The transmitter and receiver functions may share circuit components, software or firmware, or alternatively may be implemented separately.

The RAM 517 may be configured to interface via a bus 503 to the processing circuitry 501 to provide storage or caching of data or computer instructions during the execution of software programs such as the operating system, application programs, and device drivers. The ROM 519 may be configured to provide computer instructions or data to processing circuitry 501. For example, the ROM 519 may be configured to store invariant low-level system code or data for basic system functions such as basic input and output (I/O), startup, or reception of keystrokes from a keyboard that are stored in a non-volatile memory. The storage medium 521 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, the storage medium 521 may be configured to include an operating system 523, an application program 525 such as web browser, web application, user interface, browser data manager as described herein, a widget or gadget engine, or another application, and a data file 527. The storage medium 521 may store, for use by the device 500, any of a variety of various operating systems or combinations of operating systems.

The storage medium 521 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. The storage medium 521 may allow the device 500a-b to access computer-executable instructions, application programs or the like, stored on transitory or non-transitory memory media, to off-load data, or to upload data. An article of manufacture, such as one utilizing a communication system may be tangibly embodied in the storage medium 521, which may comprise a device readable medium.

The processing circuitry 501 may be configured to communicate with network 543b using the communication subsystem 531. The network 543a and the network 543b may be the same network or networks or different network or networks. The communication subsystem 531 may be configured to include one or more transceivers used to communicate with the network 543b. For example, the communication subsystem 531 may be configured to include one or more transceivers used to communicate with one or more remote transceivers of another device capable of wireless communication according to one or more communication protocols, such as IEEE 802.11, CDMA, WCDMA, GSM, LTE, UTRAN, WiMax, or the like. Each transceiver may include transmitter 533 and/or receiver 535 to implement transmitter or receiver functionality, respectively, appropriate to the RAN links (e.g., frequency allocations and the like). Further, transmitter 533 and receiver 535 of each transceiver may share circuit components, software, or firmware, or alternatively may be implemented separately.

In FIG. 5, the communication functions of the communication subsystem 531 may include data communication, voice communication, multimedia communication, short-range communications such as Bluetooth, near-field communication, location-based communication such as the use of the global positioning system (GPS) to determine a location, another like communication function, or any combination thereof. For example, the communication subsystem 531 may include cellular communication, Wi-Fi communication, Bluetooth communication, and GPS communication. The network 543b may encompass wired and/or wireless networks such as a local-area network (LAN), a wide-area network (WAN), a computer network, a wireless network, a telecommunications network, another like network or any combination thereof. For example, the network 543b may be a cellular network, a Wi-Fi network, and/or a near-field network. The power source 513 may be configured to provide alternating current (AC) or direct current (DC) power to components of the device 500a-b.

The features, benefits and/or functions described herein may be implemented in one of the components of the device 500 or partitioned across multiple components of the device 500. Further, the features, benefits, and/or functions described herein may be implemented in any combination of hardware, software, or firmware. In one example, communication subsystem 531 may be configured to include any of the components described herein. Further, the processing circuitry 501 may be configured to communicate with any of such components over the bus 503. In another example, any of such components may be represented by program instructions stored in memory that when executed by the processing circuitry 501 perform the corresponding functions described herein. In another example, the functionality of any of such components may be partitioned between the processing circuitry 501 and the communication subsystem 531. In another example, the non-computationally intensive functions of any of such components may be implemented in software or firmware and the computationally intensive functions may be implemented in hardware.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts for illustrative purposes, but the embodiments are similarly applicable in other contexts not explicitly described.

In one exemplary embodiment, a method is performed by a POS system having a first sensor device operable to sense an identifier unique to and disposed with a physical object and a second sensor device operable to capture a digital image of the physical object during checkout of that object by the POS system. Further, the POS system is communicatively coupled to a blockchain network that includes network nodes that are collectively configured to operate a blockchain having blocks, with each block having a header and a body with one or more transaction entries. The header has a reference to a previous block in the blockchain and a reference to the transaction entries of the current block in the blockchain. The unique physical object identifier is associated with a cryptographic digital asset stored on the blockchain as a code that represents the unique physical object identifier and a code that represents a reference to a virtual object obtained based on a digital image of the physical object captured by the second sensor during the checkout by the POS system. In addition, the virtual object is configured for display in a virtual or augmented reality environment displayed on a display device. The method includes receiving, from the first sensor device, the unique physical object identifier so that the virtual object reference can be obtained from the cryptographic digital asset stored on the blockchain so as to enable the virtual object to be associated with the cryptographic digital asset at the point of sale based on the virtual object reference.

In another exemplary embodiment, the method further includes determining that the physical object is associated with the cryptographic digital asset; or transferring possession of the cryptographic digital asset to a digital wallet associated with a certain user account.

In another exemplary embodiment, the method further includes outputting, for display on a presence sensitive display device of the POS system, a visual representation associated with a request to obtain a virtual object based on the physical object; receiving, from the display device, an indication of a touch gesture detected at or about the visual representation; or determining to obtain the virtual object based on the detected touch gesture.

In another exemplary embodiment, the method further includes outputting, for display on a display device of the POS system, a visual representation associated with a request to position the physical object on or about the surface of the weight scale.

In another exemplary embodiment, the method further includes receiving, by the POS system, from the second sensing device, the digital image of the physical object.

In another exemplary embodiment, the method further includes obtaining the virtual object based on the digital image of the physical object.

In another exemplary embodiment, the method further includes obtaining a visual characteristic of the physical object based on the digital image of the physical object. Further, the virtual object obtaining step is further based on the characteristic of the physical object.

In another exemplary embodiment, the virtual object obtaining step further includes obtaining a second virtual object having an appearance when displayed in a virtual or augmented reality environment of a certain form of the physical object, wherein the second virtual object is configured to be modifiable based on the visual characteristic; or modifying the second virtual object based on the visual characteristic of the physical object to obtain the virtual object.

In another exemplary embodiment, the virtual object obtaining step further includes creating the virtual object based on the digital image of the physical object. In one example, the POS system can send, to neural network circuitry, the digital image of the physical object, with the neural network circuitry being operable to provide geometry and visual modeling of the physical object based on the digital image. In response, the POS system can receive, from the neural network circuitry, the virtual object.

In another exemplary embodiment, the method further includes obtaining a blockchain reference to the cryptographic digital asset stored in the blockchain based on the unique physical object identifier; or sending, to a network node of the blockchain network, an indication that includes a request for block data associated with the cryptographic digital asset based on the blockchain reference.

In another exemplary embodiment, the method further includes receiving, from the network node of the blockchain network, the block data associated with the cryptographic digital asset, with the block data including the unique physical object identifier code and the virtual object reference code; obtaining the virtual object reference code based on the received block data; or obtaining the virtual object reference based on the virtual object reference code.

In another exemplary embodiment, the method further includes associating the virtual object to the cryptographic digital asset based on the virtual object reference; or assigning the virtual object to the virtual or augmented reality environment.

In another exemplary embodiment, the unique physical object identifier code includes a cryptographic token and a public key, with a private key associated with the unique physical object identifier code being issued to a cryptocurrency wallet account associated with the cryptographic digital asset.

In another exemplary embodiment, the virtual object reference code includes a cryptographic token and a public key, with a private key associated with the virtual object reference code being issued to a cryptocurrency wallet account associated with the cryptographic digital asset.

In another exemplary embodiment, the unique physical object identifier is associated with a quick response (QR) or bar code disposed on the outside surface of the physical object.

In one exemplary embodiment, a POS system includes a first sensor device operable to sense an identifier unique to and disposed with a physical object and a second sensor device operable to capture a digital image of the physical object during checkout of that object by the POS system. Further, the POS system is communicatively coupled to a blockchain network that includes network nodes that are collectively configured to operate a blockchain having blocks, with each block having a header and a body with one or more transaction entries. The header has a reference to a previous block in the blockchain and a reference to the transaction entries of the current block in the blockchain. The unique physical object identifier is associated with a cryptographic digital asset stored on the blockchain as a code that represents the unique physical object identifier and a code that represents a reference to a virtual object obtained based on a digital image of the physical object captured by the second sensor during the checkout by the POS system, with the virtual object being configured for display in a virtual or augmented reality environment displayed on a display device. In addition, the POS device includes processing circuitry and a memory, with the memory containing instructions executable by the processing circuitry whereby the processing circuitry is configured to receive, from the first sensor device, the unique physical object identifier so that the virtual object reference can be obtained from the cryptographic digital asset stored on the blockchain so as to enable the virtual object to be associated with the cryptographic digital asset at the point of sale based on the virtual object reference.

In another exemplary embodiment, the memory includes further instructions executable by the processing circuitry whereby the processing circuitry is configured to determine that the physical object is associated with the cryptographic digital asset; or transfer possession of the cryptographic digital asset to a digital wallet associated with a certain user account.

In another exemplary embodiment, the POS system further includes a presence sensitive display device. In addition, the memory includes further instructions executable by the processing circuitry whereby the processing circuitry is configured to output, for display on the presence sensitive display device, a visual representation associated with a request to obtain a virtual object based on the physical object; receive, from the display device, an indication of a touch gesture detected at or about the visual representation; or determine to obtain the virtual object based on the detected touch gesture.

In another exemplary embodiment, the POS system further includes a display device. In addition, the memory includes further instructions executable by the processing circuitry whereby the processing circuitry is configured to output, for display on the display device, a visual representation associated with a request to position the physical object on or about the surface of the weight scale; receive, from the second sensing device, the digital image of the physical object; or obtain the virtual object based on the digital image of the physical object.

In another exemplary embodiment, the memory includes further instructions executable by the processing circuitry whereby the processing circuitry is configured to obtain a visual characteristic of the physical object based on the digital image of the physical object; obtain a second virtual object having an appearance when displayed in a virtual or augmented reality environment of a certain form of the physical object, with the second virtual object being configured to be modifiable based on the visual characteristic; or modify the second virtual object based on the visual characteristic of the physical object to obtain the virtual object.

In another exemplary embodiment, the memory includes further instructions executable by the processing circuitry whereby the processing circuitry is configured to associate the virtual object to the cryptographic digital asset based on the virtual object reference; or assign the virtual object to the virtual or augmented reality environment.

The previous detailed description is merely illustrative in nature and is not intended to limit the present disclosure, or the application and uses of the present disclosure. Furthermore, there is no intention to be bound by any expressed or implied theory presented in the preceding field of use, background, summary, or detailed description. The present disclosure provides various examples, embodiments and the like, which may be described herein in terms of functional or logical block elements. The various aspects described herein are presented as methods, devices (or apparatus), systems, or articles of manufacture that may include a number of components, elements, members, modules, nodes, peripherals, or the like. Further, these methods, devices, systems, or articles of manufacture may include or not include additional components, elements, members, modules, nodes, peripherals, or the like.

Furthermore, the various aspects described herein may be implemented using standard programming or engineering techniques to produce software, firmware, hardware (e.g., circuits), or any combination thereof to control a computing device to implement the disclosed subject matter. It will be appreciated that some embodiments may be comprised of one or more generic or specialized processors such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the methods, devices and systems described herein. Alternatively, some or all functions could be implemented by a state machine that has no stored program instructions, or in one or more application specific integrated circuits (ASICs), in which each function or some combinations of certain of the functions are implemented as custom logic circuits. Of course, a combination of the two approaches may be used. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The term “article of manufacture” as used herein is intended to encompass a computer program accessible from any computing device, carrier, or media. For example, a computer-readable medium may include: a magnetic storage device such as a hard disk, a floppy disk or a magnetic strip; an optical disk such as a compact disk (CD) or digital versatile disk (DVD); a smart card; and a flash memory device such as a card, stick or key drive. Additionally, it should be appreciated that a carrier wave may be employed to carry computer-readable electronic data including those used in transmitting and receiving electronic data such as electronic mail (e-mail) or in accessing a computer network such as the Internet or a local area network (LAN). Of course, a person of ordinary skill in the art will recognize many modifications may be made to this configuration without departing from the scope or spirit of the subject matter of this disclosure.

Throughout the specification and the embodiments, the following terms take at least the meanings explicitly associated herein, unless the context clearly dictates otherwise. Relational terms such as “first” and “second,” and the like may be used solely to distinguish one entity or action from another entity or action without necessarily requiring or implying any actual such relationship or order between such entities or actions. The term “or” is intended to mean an inclusive “or” unless specified otherwise or clear from the context to be directed to an exclusive form. Further, the terms “a,” “an,” and “the” are intended to mean one or more unless specified otherwise or clear from the context to be directed to a singular form. The term “include” and its various forms are intended to mean including but not limited to. References to “one embodiment,” “an embodiment,” “example embodiment,” “various embodiments,” and other like terms indicate that the embodiments of the disclosed technology so described may include a particular function, feature, structure, or characteristic, but not every embodiment necessarily includes the particular function, feature, structure, or characteristic. Further, repeated use of the phrase “in one embodiment” does not necessarily refer to the same embodiment, although it may. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. A device or structure that is “configured” in a certain way is configured in at least that way, but may also be configured in ways that are not listed.

What is claimed is:

1. A method, comprising:
by a point of sale (POS) system having a first sensor device operable to sense an identifier unique to and disposed with a physical object and a second sensor device operable to capture a digital image of the physical object during checkout of that object by the POS system, the POS system being communicatively coupled to a blockchain network that includes network nodes that are collectively configured to operate a blockchain having blocks, with each block having a header and a body with one or more transaction entries, with the header having a reference to a previous block in the blockchain and a reference to the transaction entries of the current block in the blockchain, the unique physical object identifier being associated with a cryptographic digital asset stored on the blockchain as a code that represents the unique physical object identifier and a code that represents a reference to a virtual object obtained based on a digital image of the physical object captured by the second sensor during the checkout by the POS system, with the virtual object being configured for display in a virtual or augmented reality environment displayed on a display device,
receiving, from the first sensor device, the unique physical object identifier so that the virtual object reference can be obtained from the cryptographic digital asset stored on the blockchain so as to enable the virtual object to be associated with the cryptographic digital asset at the point of sale based on the virtual object reference.

2. The method of claim 1, further comprising:
determining that the physical object is associated with the cryptographic digital asset; and
transferring possession of the cryptographic digital asset to a digital wallet associated with a certain user account.

3. The method of claim 1, further comprising:
outputting, for display on a presence sensitive display device of the POS system, a visual representation associated with a request to obtain a virtual object based on the physical object;
receiving, from the display device, an indication of a touch gesture detected at or about the visual representation; and
determining to obtain the virtual object based on the detected touch gesture.

4. The method of claim 1, further comprising:
outputting, for display on a display device of the POS system, a visual representation associated with a request to position the physical object on or about the surface of the weight scale.

5. The method of claim 1, further comprising:
receiving, by the POS system, from the second sensing device, the digital image of the physical object.

6. The method of claim 5, further comprising:
obtaining the virtual object based on the digital image of the physical object.

7. The method of claim 6, further comprising:
obtaining a visual characteristic of the physical object based on the digital image of the physical object; and
wherein the virtual object obtaining step is further based on the characteristic of the physical object.

8. The method of claim 7, wherein the virtual object obtaining step further includes:
obtaining a second virtual object having an appearance when displayed in a virtual or augmented reality environment of a certain form of the physical object, wherein the second virtual object is configured to be modifiable based on the visual characteristic; and
modifying the second virtual object based on the visual characteristic of the physical object to obtain the virtual object.

9. The method of claim 1, further comprising:
obtaining a blockchain reference to the cryptographic digital asset stored in the blockchain based on the unique physical object identifier; and
sending, to a network node of the blockchain network, an indication that includes a request for block data associated with the cryptographic digital asset based on the blockchain reference.

10. The method of claim 1, further comprising:
receiving, from the network node of the blockchain network, the block data associated with the cryptographic digital asset, with the block data including the unique physical object identifier code and the virtual object reference code;
obtaining the virtual object reference code based on the received block data; and
obtaining the virtual object reference based on the virtual object reference code.

11. The method of claim 1, further comprising:
associating the virtual object to the cryptographic digital asset based on the virtual object reference; and
assigning the virtual object to the virtual or augmented reality environment.

12. The method of claim 1, wherein the unique physical object identifier code includes a cryptographic token and a public key, with a private key associated with the unique physical object identifier code being issued to a cryptocurrency wallet account associated with the cryptographic digital asset.

13. The method of claim 1, wherein the virtual object reference code includes a cryptographic token and a public key, with a private key associated with the virtual object reference code being issued to a cryptocurrency wallet account associated with the cryptographic digital asset.

14. The method of claim 1, wherein the unique physical object identifier is associated with a quick response (QR) or bar code disposed on the outside surface of the physical object.

15. A point of sale (POS) system, comprising:
a first sensor device operable to sense an identifier unique to and disposed with a physical object;
a second sensor device operable to capture a digital image of the physical object during checkout of that object by the POS system;
wherein the POS system is communicatively coupled to a blockchain network that includes network nodes that are collectively configured to operate a blockchain having blocks, with each block having a header and a body with one or more transaction entries, with the header having a reference to a previous block in the blockchain and a reference to the transaction entries of the current block in the blockchain, the unique physical object identifier being associated with a cryptographic digital asset stored on the blockchain as a code that represents the unique physical object identifier and a code that represents a reference to a virtual object obtained based on a digital image of the physical object captured by the second sensor during the checkout by the POS system, with the virtual object being configured for display in a virtual or augmented reality environment displayed on a display device; and
wherein the POS device further includes processing circuitry and a memory, the memory containing instructions executable by the processing circuitry whereby the processing circuitry is configured to:
receive, from the first sensor device, the unique physical object identifier so that the virtual object reference can be obtained from the cryptographic digital asset stored on the blockchain so as to enable the virtual object to be associated with the cryptographic digital asset at the point of sale based on the virtual object reference.

16. The POS system of claim 15, wherein the memory includes further instructions executable by the processing circuitry whereby the processing circuitry is configured to:
determine that the physical object is associated with the cryptographic digital asset; and
transfer possession of the cryptographic digital asset to a digital wallet associated with a certain user account.

17. The POS system of claim 15, wherein the POS system further includes:
a presence sensitive display device; and
wherein the memory includes further instructions executable by the processing circuitry whereby the processing circuitry is configured to:
output, for display on the presence sensitive display device, a visual representation associated with a request to obtain a virtual object based on the physical object;
receive, from the display device, an indication of a touch gesture detected at or about the visual representation; and
determine to obtain the virtual object based on the detected touch gesture.

18. The POS system of claim 15, wherein the POS system further includes:
a display device; and
wherein the memory includes further instructions executable by the processing circuitry whereby the processing circuitry is configured to:
output, for display on the display device, a visual representation associated with a request to position the physical object on or about the surface of the weight scale;
receive, from the second sensing device, the digital image of the physical object; and
obtain the virtual object based on the digital image of the physical object.

19. The POS system of claim 15, wherein the memory includes further instructions executable by the processing circuitry whereby the processing circuitry is configured to:
obtain a visual characteristic of the physical object based on the digital image of the physical object;
obtain a second virtual object having an appearance when displayed in a virtual or augmented reality environment of a certain form of the physical object, wherein the second virtual object is configured to be modifiable based on the visual characteristic; and
modify the second virtual object based on the visual characteristic of the physical object to obtain the virtual object.

20. The POS system of claim 15, wherein the memory includes further instructions executable by the processing circuitry whereby the processing circuitry is configured to:
associate the virtual object to the cryptographic digital asset based on the virtual object reference; and
assign the virtual object to the virtual or augmented reality environment.
